(19) United States
(12) Patent Application Publication
(10) Pub. No.: US 2016/0345484 A1
(43) Pub. Date: Dec. 1, 2016

(54) Garden Tool Device

(71) Applicant: Roberto Rojas, Lodi, CA (US)

(72) Inventor: Roberto Rojas, Lodi, CA (US)

(21) Appl. No.: 14/724,419

(22) Filed: May 28, 2015

(51) Int. Cl. A01B 1/20

(52) U.S. Cl. CPC A01B 1/20

(57) ABSTRACT

A garden tool device facilitates manipulation of soil, removal or cutting of weeds, cleaning joints between concrete, landscape design and the like. The device includes a head and a handle. A perimeter edge of the head defines a rectangular parallelogram. Each of a plurality of grooves extends into the perimeter edge of the head. The grooves are spaced along the perimeter edge of the head. The handle is coupled to and extends from the head.

### BACKGROUND OF THE DISCLOSURE

### Field of the Disclosure

The disclosure relates to tool devices and more particularly pertains to a new tool device for facilitating manipulation of soil, removal or cutting of weeds, cleaning joints between concrete, landscape design and the like.

### SUMMARY OF THE DISCLOSURE

An embodiment of the disclosure meets the needs presented above by generally comprising a head and a handle. A perimeter edge of the head defines a rectangular parallelogram. Each of a plurality of grooves extends into the perimeter edge of the head. The grooves are spaced along the perimeter edge of the head. The handle is coupled to and extends from the head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a garden tool device according to an embodiment of the disclosure.

FIG. 2 is a cross-sectional view of an embodiment of the disclosure taken along line 2-2 of FIG. 1.

FIG. 3 is a side view of an embodiment of the disclosure.

FIG. 4 is a bottom view of an embodiment of the disclosure.

FIG. 5 is a top front side perspective view of an embodiment of the disclosure.

### DESCRIPTION OF THE PREFERRED EMBODIMENT

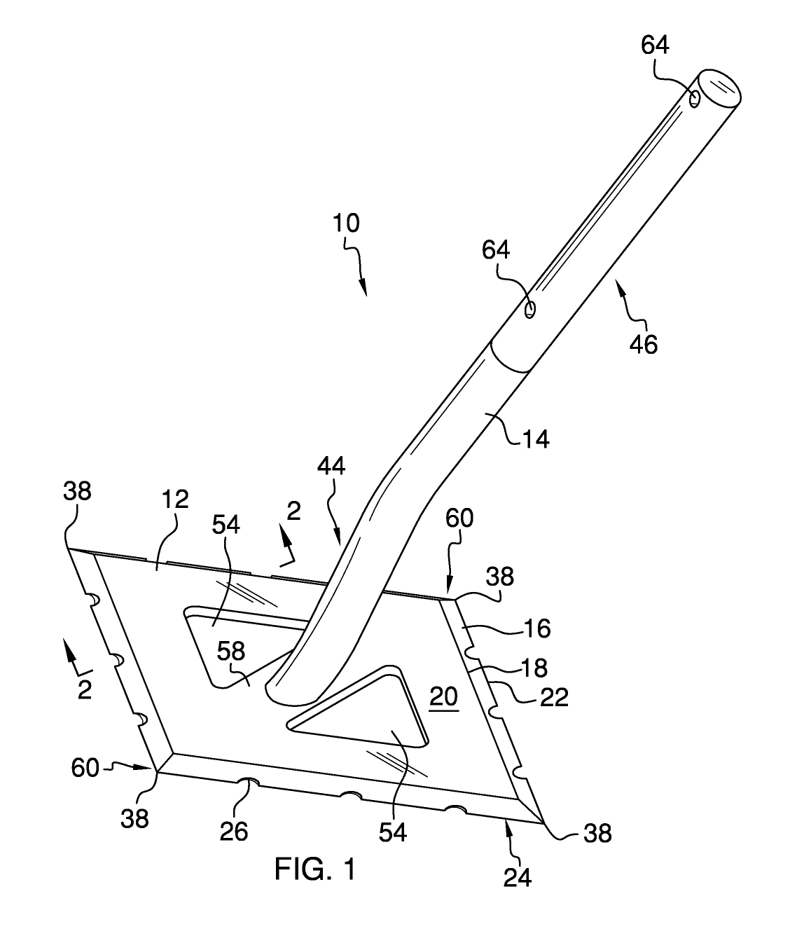

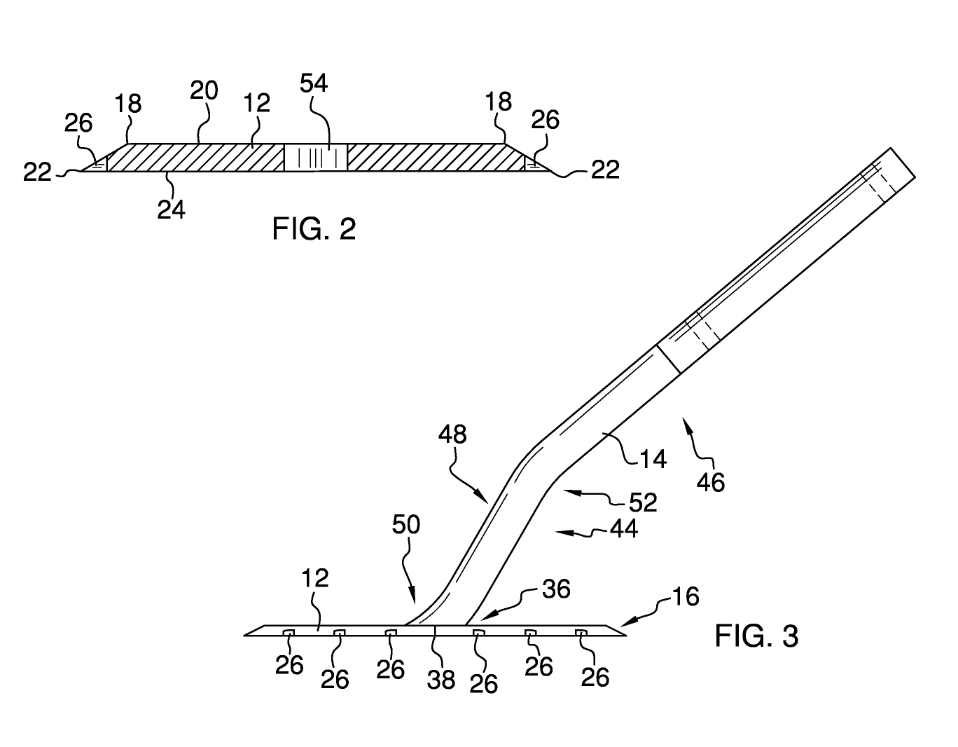

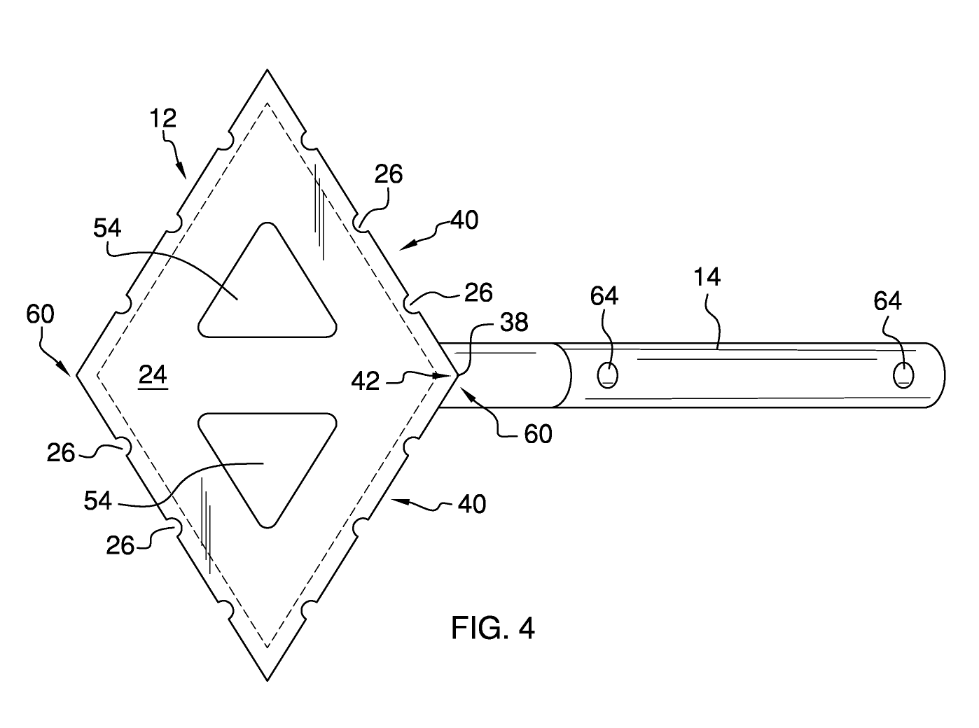

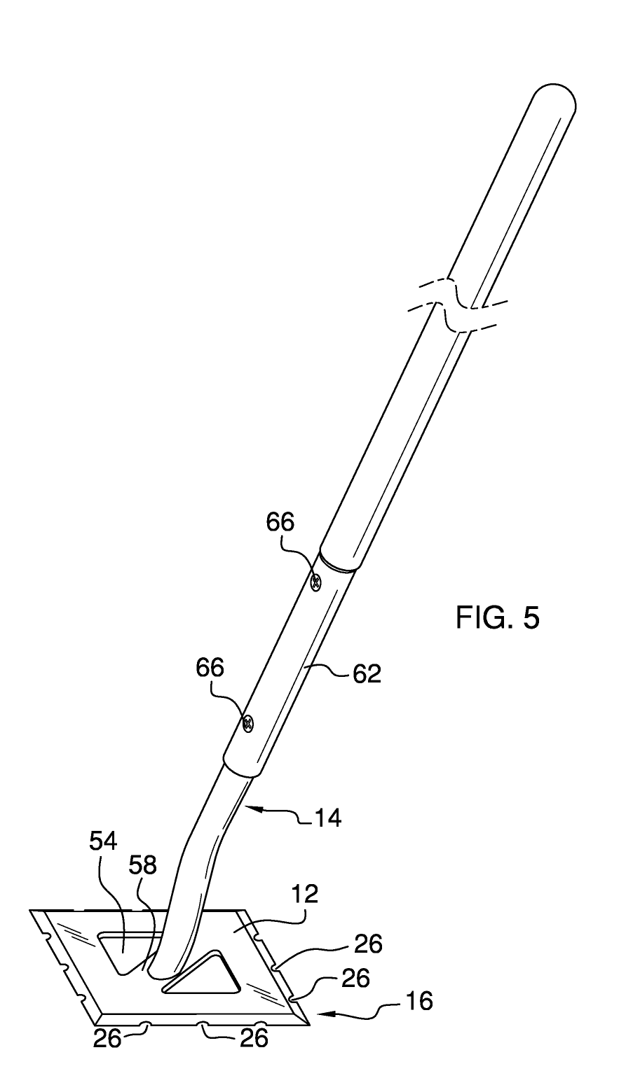

With reference now to the drawings, and in particular to FIGS. 1 through 5 thereof, a new tool device embodying the principles and concepts of an embodiment of the disclosure and generally designated by the reference numeral 10 will be described.

As best illustrated in FIGS. 1 through 5, the garden tool device 10 generally comprises a head 12 and a handle 14. The head 12 has a perimeter edge 16. The perimeter edge 16 defines a rectangular parallelogram. Long sides of the perimeter edge may be between 10 and 15 centimeters and the short sides of the perimeter edge 16 may be between 15 and 25 centimeters. The head 12 may be formed from a plate having a thickness between 2 and 5 millimeters. The perimeter edge 16 of the head 12 is beveled such that a peripheral edge 18 of a top surface 20 of the head 12 is inset from a peripheral edge 22 of a bottom surface 24 of the head 12.

Each of a plurality of grooves 26 extends into the perimeter edge 16 of the head 12. The grooves 26 are spaced along the perimeter edge 16 of the head 12. Each of the grooves 26 has a semi-circular shape and is positioned entirely between the peripheral edge 18 of the top surface 20 and the peripheral edge 22 of the bottom surface 24. The grooves 26 are arranged into a respective central groove 28 and a respective pair of outer grooves 30 positioned on each side 32 of the perimeter edge 16 of the head 12.

The handle 14 is coupled to and extends from the head 12. The handle 14 extends from the top surface 20 of the head 12 such that the handle 14 forms an acute angle 36 with the top surface 20 of the head 12. The handle 14 extends outwardly from the top surface 20 of the head 12 and aligns with one of a plurality of corners 38 of the head 12 where adjacent sections 40 of the perimeter edge 16 define an obtuse angle 42 of the rectangular parallelogram. The handle 14 has a first section 44 and a second section 46. The first section 44 is coupled to the head 12 and may have a straight distal portion 48 relative to the head and a curved portion 50 adjacent to the head 12. The second section 46 is coplanar with the first section 44. The second section 46 extends from the first section 44 at an obtuse angle 52 within a transverse plane relative to the top surface 20 of the head 12. The second section 46 extends away from the head 12 at an angle between 35 and 45 degrees.

Each of a pair of cutouts 54 extends through the head 12. Each cutout 54 is triangular having a pair of outer edges 56. Each of the outer edges 56 extends parallel to an associated straight side 32 of the perimeter edge 16 of the head 12. The cutouts 54 define an elongated strip 58 of the head 12 extending between opposite corners 60 of the head 12. The opposite corners 60 each define an obtuse angle. The handle 14 is coupled to and extends from the elongated strip 58.

The handle 14 may have a length between 20 and 30 centimeters wherein the handle 14 is suitable as a hand tool usable by a single hand while in a kneeling position similar to a conventional trowel. An extension 62 is removably coupled to the handle 14 to allow the head 12 to be manipulated while in a standing position. The extension 62 is elongated. The extension 62 is linearly aligned with the second section 46 of the handle 14 when the extension 62 is coupled to the handle 14. Each of a pair of mounting holes 64 extends into the second section 46 of the handle 14. Each of a pair of fasteners 66 is insertable through the extension 62 and an associated one of the mounting holes 64. Each fastener 66 engages the handle 14 wherein the extension 62 is secured to the handle 14.

In use, the head 12 is manipulated to agitate, break up, shape, or otherwise work with soil to achieve a desired result. The grooves 26 may be positioned to receive a root allowing the root to be pulled on instead of cut by the peripheral edge 22 of the bottom surface 24. The handle 14, with or without the extension 62, is used to manipulate the head 12 to perform the desired gardening and landscaping tasks.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A garden tool device comprising:
a head, said head having a perimeter edge, said perimeter edge defining a rectangular parallelogram;
a plurality of grooves extending into said perimeter edge of said head, said grooves being spaced along said perimeter edge of said head; and
a handle coupled to and extending from said head.

2. The device of claim 1, further comprising said perimeter edge of said head being beveled.

3. The device of claim 1, further comprising each of said grooves having a semi-circular shape.

4. The device of claim 3, further comprising said grooves being arranged into a respective central groove and a respective pair of outer grooves positioned on each side of said perimeter edge of said head.

5. The device of claim 1, further comprising said handle extending from a top surface of said head such that said handle forms an acute angle with said top surface of said head.

6. The device of claim 5, further comprising said handle extending outwardly from said top surface of said head and aligning with one of a plurality of corners of said head.

7. The device of claim 5, further comprising said handle extending outwardly from said top surface of said head and aligning with one of a plurality of corners of said head where adjacent sections of said perimeter edge define an obtuse angle.

8. The device of claim 1, further comprising said handle having a first section and a second section, said first section being coupled to said head, said second section being coplanar with said first section, said second section extending from said first section at an obtuse angle within a transverse plane relative to said top surface of said head.

9. The device of claim 1, further comprising an extension removably coupled to said handle, said extension being elongated.

10. The device of claim 8, further comprising an extension removably coupled to said handle, said extension being elongated, said extension being linearly aligned with said second section of said handle.

11. The device of claim 10, further comprising:
a pair of mounting holes extending into said second section of said handle; and
a pair of fasteners, each said fastener being insertable through said extension and an associated one of said mounting holes, each fastener engaging said handle wherein said extension is secured to said handle.

12. The device of claim 1, further comprising said head having a pair of cutouts, each said cutout being triangular, each said cutout having a pair of outer edges, each of said outer edges extending parallel to an associated straight side of said perimeter edge of said head.

13. The device of claim 12, further comprising said cutouts defining an elongated strip of said head extending between opposite corners of said head, said handle being coupled to and extending from said elongated strip.

14. A garden tool device comprising:
a head, said head having a perimeter edge, said perimeter edge defining a rectangular parallelogram, said perimeter edge of said head being beveled;
a plurality of grooves extending into said perimeter edge of said head, said grooves being spaced along said perimeter edge of said head, each of said grooves having a semi-circular shape, said grooves being arranged into a respective central groove and a respective pair of outer grooves positioned on each side of said perimeter edge of said head;
a handle coupled to and extending from said head, said handle extending from a top surface of said head such that said handle forms an acute angle with said top surface of said head, said handle extending outwardly from said top surface of said head and aligning with one of a plurality of corners of said head where adjacent sections of said perimeter edge define an obtuse angle, said handle having a first section and a second section, said first section being coupled to said head, said second section being coplanar with said first section, said second section extending from said first section at an obtuse angle within a transverse plane relative to said top surface of said head;
a pair of cutouts extending through said head, each said cutout being triangular, each said cutout having a pair of outer edges, each of said outer edges extending parallel to an associated straight side of said perimeter edge of said head, said cutouts defining an elongated strip of said head extending between opposite corners of said head, said handle being coupled to and extending from said elongated strip;
an extension removably coupled to said handle, said extension being elongated, said extension being linearly aligned with said second section of said handle;
a pair of mounting holes extending into said second section of said handle; and
a pair of fasteners, each said fastener being insertable through said extension and an associated one of said mounting holes, each fastener engaging said handle wherein said extension is secured to said handle.
